(19) United States
(12) Patent Application Publication
(10) Pub. No.: US 2004/0123705 A1
(43) Pub. Date: Jul. 1, 2004

(54) Screwdriver Handle with Rotatable End Cap

(75) Inventor: Westley W. Howard, Colorado Springs, CO (US)

Correspondence Address: HOWREY SIMON ARNOLD & WHITE LLP, 750 BERING DRIVE, HOUSTON, TX, 77057, US

(73) Assignee: EMERSON ELECTRIC CO., St. Louis, MO (US)

(21) Appl. No.: 10/248,204

(22) Filed: Dec. 26, 2002

(51) Int. Cl. B25G 1/00

(52) U.S. Cl. 81/492

(57) ABSTRACT

A screwdriver handle is disclosed that facilitates storage and organization of screwdriver bits by supplying individual compartments for bits of different sizes and functions within the screwdriver handle. An operator may easily access a particular bit by rotating a cap and aligning its opening with the compartment containing the desired bit. The cap need not be removed from the body of the handle to remove a desired bit. A ratchet mechanism allows for selective and precise rotation of the cap. After the bit is selected, the operator returns the cap to a closed position so that all of the bits are securely stored inside the handle.

### BACKGROUND OF INVENTION

This invention relates generally to the field of hand tools, and more particularly to a screwdriver that stores a number of interchangeable bits in its body such that the bits are readily accessible.

Hand tool handles generally have solid bodies, though some hand tools that employ interchangeable bits include hollowed bodies capable of storing bits in addition to the bit attached to the bit holder. In many prior art tools, bits are loosely stored in a compartment in the handle. Other prior art tools have handles with several compartments wherein each individual bit is held in a separate compartment. Examples of such tools are disclosed in U.S. Pat. Nos. 4,241,773; 4,552,044; 4,924,733; 5,174,178; 6,237,451; 6,327,942; and 6,378,407. These tools typically include a large number of moving parts. In addition, some of these tools require excessive manipulation by the operator. For example, many tools require an operator to either remove a handle cap to retrieve a bit. As a further example, the tool disclosed in U.S. Pat. No. 5,174,178 requires an operator to unsnap an access door to a bit compartment before the bit can be removed. Alternatively, a screwdriver handle could include a variety of individual bits, partially lodged in tight fitting hexagonal holes near its shaft. For example, U.S. Pat. No. 6,293,173 discloses a screwdriver with a bit holder located near the shaft of the screwdriver.

While conventional hand tools of the kind described above offer many advantages for hand tool users, they nevertheless remain cumbersome to use, and are often expensive and complex to make because they contain numerous moving parts. Often such tools also do not provide quick and easy access to the interchangeable bits because of the number of steps required to gain such access. Likewise, screwdriver handles that partially lodge the bits near their shafts can be ineffective and even dangerous. When the tool points downward, the bits are prone to fall from their holes into the field of operation, which may interrupt the work or cause injury. But even bits that remain in place pose a hazard to an operator. A screwdriver under heavy downward pressure may slip off the screw and gouge the operator's hand on the sharp edge of a stored bit. Tools having handles with single compartments for bit storage can be disorganized, allowing bits of different types and sizes to mix during use. Finding the appropriate bit may require a user to tediously unscrew the cap, empty the compartment completely, and sift through all of the bits to find the desired piece. This procedure can be very cumbersome or even impossible when working in tight spaces or at awkward angles and can lead to bits being lost or misplaced.

Therefore, a need exists for a tool handle capable of storing bits in an organized but accessible manner in a safe location of the handle. This invention offers just such an alternative solution.

### SUMMARY OF INVENTION

In view of the foregoing and other considerations, the present invention relates to a hand tool handle for holding and individually selecting bits in an organized, easily accessible, and safe manner. The present invention provides a tool handle with organized bit storage in individual compartments for bits of different sizes and functions. The end cap need not be removed from the handle body to remove a desired bit. An operator may easily access a particular bit by rotating the end cap to align its opening with the compartment containing the desired bit. A ratcheting mechanism allows for selective and precise rotation of the cap. After the bit is selected, the operator returns the cap to a closed position so that the remaining bits are securely stored inside the handle.

In one embodiment, the present invention provides a substantially cylindrical tool handle that has several individual compartments, each adapted to store an interchangeable bit, and an axial bore in the center of the handle body. The compartments extend axially inward from the end surface of the handle and are arranged radially around an axial bore in the handle. The handle also includes a rotatably attached end cap that includes a surface that is close to the body of the handle. This end cap surface at least partially covers the bit compartments, has an opening to allow a bit to pass through, and has at least one projection extending partially into one of the bit compartments to secure the end cap against free rotation. To remove a bit from one of the bit compartments, an operator can twist the end cap and align the opening in the end cap with the appropriate compartment and invert the screwdriver. The bit can be replaced in the compartment in the same manner, and the operator can align the opening in the end cap to an empty compartment for safe storage of the screwdriver.

Other embodiments of the present invention include a screwdriver having a handle of the type described above, and an end cap for such a handle.

### BRIEF DESCRIPTION OF DRAWINGS

Other objects and advantages of the invention will become apparent upon reading the following detailed description and upon reference to the drawings in which:

FIG. 1A depicts an exemplary tool of the present invention with an interchangeable bit in place for operation.

FIG. 1B depicts another exemplary tool of the present invention with an alternative embodiment of the end cap.

FIG. 2 depicts a side view of the handle body of the same tool without a shaft or the end cap attached.

FIG. 3A depicts an end view of the handle body, showing the end surface of the handle without the end cap.

FIG. 3B depicts a perspective view of the first and second ends of the handle body without a shaft or end cap.

FIG. 4 depicts a side cross-sectional view of the handle body without the shaft, the interchangeable bits, or the end cap.

FIG. 5A depicts a side view of the end cap of the handle.

FIG. 5B depicts another side view of the same end cap.

FIG. 5C depicts a perspective view of the same end cap as shown in FIGS. 5A and 5B.

FIG. 5D depicts a top view of the same end cap.

FIG. 5E depicts a front view of the inner end surface of the end cap, which is proximate to the surface of the body of the handle.

FIGS. 5F and 5G depict perspective and top views, respectively, of the alternative embodiment of the end cap shown in FIG. 1B.

FIG. 6 depicts a detail view of the end of the axle of the end tap.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is intended to cover all modifications, equivalents and alternatives falling within the scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

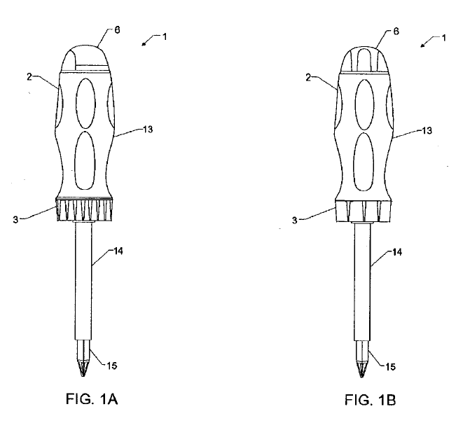

Illustrative embodiments will now be described with reference to the accompanying figures. FIG. 1A depicts a screwdriver 1 constructed according to the present invention. Screwdriver 1 includes a handle body that includes a first end 2, substantially cylindrical body 13, and a second end 3 capable of receiving a shaft 14. In one embodiment of the invention, shaft 14 is detachable from second end 3 of the screwdriver. Alternatively, shaft 14 can be permanently coupled to second end 3 of the screwdriver. In especially preferred embodiments of this invention, shaft 14 is coupled to second end 3 by a ratcheting mechanism. Many suitable ratcheting mechanisms are known in the art. Suitable mechanisms are disclosed, for example, in U.S. Pat. Nos. 6,370,988; 5,788,743; 5,771,760; and 5,613,585, the disclosures of which are incorporated herein by reference. Shaft 14 is capable of receiving any one of several interchangeable bits 15. End cap 6 is rotatably coupled to first end 2 to form the end of the handle.

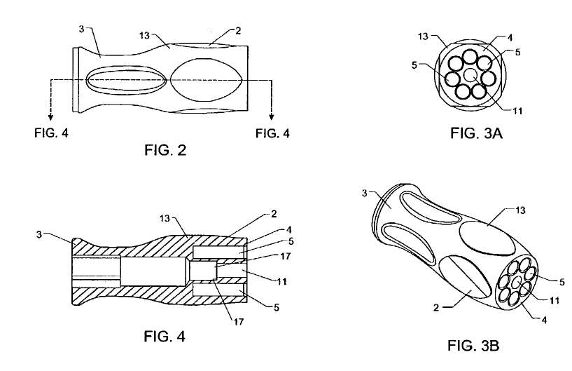

As may be seen in FIG. 2, first end 2 includes an end surface 4. FIGS. 3A, 3B, and 4 show first end 2 with compartments 5 and axial bore 11 both extending axially inward from end surface 4. In especially preferred embodiments, first end 2 has five to seven compartments 5. In the embodiment shown, first end 2 has seven circular compartments 5 each adapted to store an interchangeable bit 15. Compartments 5 are arranged radially around axial bore 11.

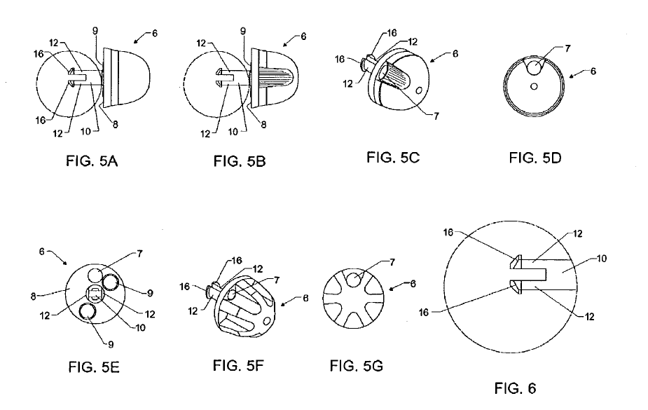

A preferred embodiment of the end cap 6 is shown in FIGS. 5A through 5E. As may be seen in the Figures, end cap 6 includes an axle 10 coupled to end cap 6 at end cap surface 8 and extending distally therefrom. In one embodiment of the invention shown in FIGS. 5A5E and 6, a locking mechanism is used to rotatably couple end cap 6 to the first end 2. The locking mechanism includes axle 10, which has two prongs 12 separated by empty space and ending in hooks 16. Hooks 16 extend outward from the body of prongs 12. Prongs 12 are flexible enough to allow axle 10 to be fully inserted into axial bore 11 but rigid enough to hold end cap 6 in place. When axle 10 is fully inserted into axial bore 11, hooks 16 on prongs 12 engage two edges 17 in axial bore 11 (which are shown in FIG. 4) to secure end cap 6. This results in a rotatable coupling of end cap 6 to first end 2, which together constitute the handle. Alternatively, other locking mechanisms and means for rotatably coupling and securing end cap 6 to first end 2 may be used. For example, axle 10 could be replaced with a fastener, such as a bolt, a rivet or screw. In one embodiment (not shown), the fastener could be a stud bolt secured in the first end 2, and the end cap may be attached to the stud bolt by a nut.

It will be appreciated that many of the features of the preferred embodiment of end cap 6 as shown in FIGS. 5A through 5E are not essential to its function. For example, the end cap shown in FIGS. 1B, 5F, and 5G includes additional decorative grooves to provide a more symmetrical appearance. As a further example, the rounded shape of the end cap is not required, and the end cap could be a flat disc covering compartment 5.

Surface 8 of end cap 6 also includes an opening 7 that may be aligned with any of the compartments 5 in first end 2 by rotating the end cap. Opening 7 is sized to permit a bit to pass through. In a preferred embodiment, at least one projection 9 extends from surface 8 of end cap 6. In the embodiment shown, projection 9 is formed of a rubber or plastic material and may be integrally molded with end cap 6 or attached thereto. At least one projection 9 extends slightly into at least one compartment 5 to resist free rotation of end cap 6 relative to first end 2. Projection 9 is preferably sized to fit closely within compartment 5 and to extend into the compartment only a short distance so that end-cap 6 may still be rotated by applying a slight rotational force. This allows for ratcheting rotation of end cap 6 relative to cylindrical body 13. To remove a desired bit from a compartment 5, an operator of the tool rotates end cap 6 to align opening 7 with the compartment containing the desired bit. An operator may select a bit by viewing the bits through opening 7. The operator may then remove the desired bit 15 from compartment 5 by simply inverting the screwdriver to allow bit 15 to slide out of compartment 5 through opening 7.

When an operator is finished using a bit, he can store the bit by aligning opening 7 over an empty compartment 5 and inserting the bit through opening 7 into compartment 5. Screwdriver 1 can be stored with opening 7 aligned over an empty compartment 5. This prevents any of the bits 15 from falling out of compartments 5. In an alternative embodiment, one of the compartments S is omitted from the first end 2 so that the opening 7 may be rotated to a position where it is not aligned with any compartment, thereby allowing bits in all of the compartments to be retained.

While the invention has been described with reference to the preferred embodiments, obvious modifications and alterations are possible by those skilled in the related art. Therefore, it is intended that the invention include all such modifications and alterations to the full extent that they come within the scope of the following claims or the equivalents thereof.

1. a screwdriver having a first end comprising a handle and a second end adapted to receive one of a plurality of interchangeable bits, wherein the handle further comprises:
a substantially cylindrical body having an end surface at a distal end thereof;
a plurality of compartments extending axially inward from said end surface and arranged radially about a longitudinal axis of said body, each compartment adapted to receive at least one of said interchangeable bits; and
an end cap rotatably coupled to the end surface and at least partially covering the compartments, the end cap having an opening therethrough that is alignable with any selected one of the compartments, said opening being of sufficient size to allow one of said bits to pass therethrough into or out of said one of the compartments, wherein the end cap comprises an end cap surface proximate to the end surface of the body, said end cap surface comprising at least one projection that extends into another of said compartments to resist rotation of the end cap relative to the body.

2. A screwdriver according to claim 1 wherein said substantially cylindrical body comprises a ratcheting mechanism.

3. A screwdriver according to claim 1 wherein said plurality of compartments consists of 5, 6, or 7 compartments.

4. A screwdriver according to claim 1, wherein said end cap is rotatably coupled to the end surface by a fastener.

5. A screwdriver according to claim 4, wherein the fastener is selected from the group consisting of bolts, screws and rivets.

6. A screwdriver according to claim 5, wherein the fastener is a stud bolt secured in said end surface, and the end cap is secured to said stud bolt by a nut.

7. A screwdriver according to claim 1, wherein an axle extends distally from the end cap surface into an axial bore of the body.

8. A screwdriver according to claim 7, wherein the axle comprises a locking mechanism that secures the axle within the axial bore when the axle is fully inserted into the axial bore but permits the end cap to rotate on the axle relative to the body.

9. A screwdriver according to claim 8 , wherein the locking mechanism comprises:
a lip in the axial bore; and
a plurality of prongs on the end of the axle, said prongs separated by an empty space
and each terminating with a hook, wherein the prongs are sufficiently flexible to allow insertion of said axle into said axial bore but sufficiently rigid to retain said axle in said axial bore, and wherein the hooks extend outward from the body of said prongs such that when the axle is fully inserted into said axial bore, the hooks engage the lip to secure the axle within the axial bore.

10. A handle for a screwdriver comprising:
a substantially cylindrical body having an end surface at one end thereof;
a plurality of compartments extending axially inward from said end surface and arranged radially about a longitudinal axis of said body, each compartment adapted to receive an interchangeable bit for said screwdriver; and
an end cap rotatably coupled to the end surface and at least partially covering the compartments, the end cap having an opening therethrough that is alignable with any selected one of the compartments, said opening being of sufficient size to permit one of said bits to pass therethrough into or out of said one of the compartments, wherein the end cap includes an end cap surface proximate to the end surface of the body, said end cap surface including at least one projection that extends into another of said compartments to resist rotation of the end cap relative to the body.

11. The handle of claim 10, wherein an axle extends distally from the end cap surface into an axial bore of the body.

12. The handle of claim 11, wherein the axle comprises a locking mechanism that secures the axle within the axial bore when the axle is fully inserted into the axial bore but permits the end cap to rotate on the axle relative to the body.

13. The handle of claim 12, wherein the locking mechanism comprises:
a lip in the axial bore; and
a plurality of prongs on the end of the axle, said prongs separated by an empty space and each terminating with a hook, wherein the prongs are sufficiently flexible to allow insertion of said axle into said axial bore but sufficiently rigid to retain said axle in said axial bore, and wherein the hooks extend outward from the body of said prongs such that when the axle is fully inserted into said axial bore, the hooks engage the lip to secure the axle within the axial bore.

14. A handle according to claim 10 wherein said plurality of compartments consists of 5, 6, or 7 compartments.

15. A handle according to claim 10 wherein said plurality of compartments consists of seven compartments.

16. A handle according to claim 10, wherein said end cap is rotatably coupled to the end surface by a fastener.

17. A handle according to claim 16, wherein the fastener is selected from the group consisting of bolts, screws and rivets.

18. A handle according to claim 17, wherein the fastener is a stud bolt secured in said end surface, and the end cap is secured to said stud bolt by a nut.

19. An end cap adapted to be rotatably mounted on an end surface of a substantially cylindrical body having an containing a plurality of bores extending axially into said body from said end surface and arranged radially about a center point on said end surface, each said bore adapted to receive a tool, wherein the end cap comprises:
an end cap surface proximate to the end surface of the body and at least partially covering said bores, said end cap surface including at least one distally extending projection that extends into one of said bores to resist rotation of the end cap relative to the body; and
an opening extending through the end cap and end cap surface, wherein rotation of the end cap relative to the body permits the opening to be aligned with any selected one of the bores for insertion of a tool thereinto or extraction of a tool therefrom.
